(19) United States
(12) Patent Application Publication
(10) Pub. No.: US 2014/0240331 A1
(43) Pub. Date: Aug. 28, 2014

(54) DISPLAY DEVICE, SYSTEM AND METHOD FOR MONITORING AT LEAST ONE PROPERTY THEREOF

(71) Applicants: Stuart Norton, Westerham (GB); Petresz Gabor, Szekesfehervar (HU); Nicholas How, West Wickham (GB)

(72) Inventors: Stuart Norton, Westerham (GB); Petresz Gabor, Szekesfehervar (HU); Nicholas How, West Wickham (GB)

(21) Appl. No.: 14/114,128

(22) PCT Filed: Apr. 26, 2012
(86) PCT No.: PCT/GB2012/050917

§ 371 Date: Nov. 12, 2013

(30) Foreign Application Priority Data
Apr. 28, 2011 (GB) 1107167.7

(51) Int. Cl. G09G 5/00

(52) U.S. Cl. CPC G09G 5/006
USPC 345/520

(57) ABSTRACT

A display device (10) comprises an input/output channel for receiving data from a source and at least one sensor (36) operable to obtain sensor data on the display device (10). Selected ones of the or each sensor (36) are arranged to operate in response to the display device (10) receiving a request in the data from the source via the input/output channel, and the display device (10) is arranged to output the sensor data obtained by the or each sensor (36) to the source via the input/output channel. A system for monitoring at least one property of such a display device (10) comprises a monitoring unit (32) which is connectable to the one or more sensors (36) via the input/output channel to provide the request and receive the sensor data from the one or more sensors (36). The system can thereby monitor at least one property of the display device (10).

### FIELD OF THE INVENTION

The present invention relates to a display device, and to a system and method for monitoring at least one property of a display device.

### BACKGROUND TO THE INVENTION

Display devices are often used in public places, either as stand-alone displays or linked with a series of other displays. Linked displays are used in a variety of applications such as digital signage, the entertainment industry, gaming (such as in gambling installations), kiosks, cash machines (ATMs), photo machines and vending machines. Frequently, such display systems are inaccessible, unattended or maintained only by untrained staff.

There is currently no way of centrally detecting faults on displays used in public places, such as black-screens caused by electronics failures, backlight failures, faulty touchscreens, cracked screens and the like. Such faults can cause a display to experience down time, when the display is not showing the information it is meant to. Even if a display is partially operational, any effect on visual output will have a knock-on to the desirability to use/view the display. Such down time is costly, and maintenance can often only take place after the fault is reported, for example by on-site staff or on-the-road maintenance engineers. Displays used in, for example, gambling installations can also become damaged by use over time, by accident or malicious damage by angry users. Sometimes this is after a number of jolts or punches to the screen, which could possibly be prevented.

In addition to the above, in recent years the preferred light source for display devices has changed from high-voltage, high-power fluorescent backlighting to low-voltage, low-power light emitting diode (LED) panel backlighting. Whilst there are a number of advantages associated with the use of LED panels as backlighting for displays, LED panels are known to have a relatively short lifetime. As many public displays are operable for large amounts of time, often 24 hours a day, this can lead to displays burning out in a relatively short period of time.

### STATEMENT OF INVENTION

According to an aspect of the present invention, there is provided a display device comprising:

an input/output channel for receiving data from a source; and

at least one sensor operable to obtain sensor data on the display device, at least selected ones of the or each sensor being arranged to operate in response to the display device receiving a request in the data from the source via the input/output channel;

the display device being arranged to output the sensor data obtained by the or each sensor to the source via the input/output channel.

Embodiments of the present invention are particularly applicable to display devices such as LCDs, Plasma displays, CRT displays and the like. In preferred embodiments, sensor(s) and associated monitoring components are integrated into or otherwise added to the display device. Communications to and from the sensor(s) are preferably piggy-backed onto an existing communication channel such as the audio-visual data channel from a source that drives the display device.

The display device may further comprise a graphics subsystem in communication with the input/output channel, wherein the at least selected ones of the sensors being arranged to operate in response to the graphics subsystem receiving the request in data from the source.

The graphics subsystem may include an A/D converter.

The input/output channel may include extended display identification formatted data.

The display device may further comprise a sensor controller, the sensor controller being arranged to monitor the input/output channel for the request and selectively control one or more of the sensors in dependence on the request.

The or each sensor may be operable to obtain respective data about a property of the display device selected from a list comprising: haptic feedback, backlight brightness, backlight inverter current, ambient light, touch overlay, touch controller, shock, internal temperature colour gamut and user proximity.

The display device may further comprise a device controller operable to control at least one property of the display device, the device controller being arranged to operate in response to the display device receiving a request to control the at least one property of the display device via the input/output channel.

The at least one property may be selected from: backlight power and backlight brightness.

The device controller may be arranged to control the property whereby the display appears non-operational.

The device controller may be arranged to control the property to revert the display to an operational appearance after a predetermined time.

According to another aspect of the present invention, there is provided a system for monitoring at least one property of a display device, the system comprising:

a display device according to any preceding claim; and,

a monitoring unit;

wherein the monitoring unit is connectable to the one or more sensors via the input/output channel to provide the request and receive the sensor data from the one or more sensors to thereby monitor the at least one property of the display device.

The monitoring unit may be encoded in a display device driver, the display device driver being arranged to be executed on a source computer connected via the input/output channel to the display for displaying content from the source.

The display device driver may be arranged to act as an intermediary bridging between a node connected to the source on a data network and the one or more sensors, the display device driver being arranged to relay the request and sensor data between the one or more sensors and the node.

The monitoring unit may be arranged to communicate with a data communication network.

The monitoring unit may be a display adapter.

The display device may include the monitoring unit.

According to another aspect of the present invention, there is provided a method of monitoring at least one property of a display device having at least one sensor associated with the display device and operable to obtain respective data about a property of the display device, the method comprising:

generating a request at a monitoring unit for the display device to poll the or each sensor; and

receiving data obtained by the or each sensor in response to the request.

The request to poll the or each sensor may comprise a request to obtain respective data about a property of the display device selected from a list comprising: haptic feedback, backlight brightness, backlight inverter current, ambient light, touch overlay, touch controller, shock, internal temperature and user proximity.

The method may further comprise controlling at least one property of the display device, in response to the display device receiving a request to control the at least one property of the display device.

The at least one property may be selected from: backlight power and backlight brightness.

In embodiments of the present invention display devices can be connected to an over-the-air data network such as the Internet, in which case the present invention can be utilised in order to immediately report an error on a system to a remote control centre. The nature of the error can also be reported to the control centre.

Embodiments of the present invention allow the collection of data relating to a number of different properties of the display devices, by using a number of different sensors in each of the displays. The status or health of the system can then be presented to either a local computer connected to the display device, or through a network for example with the local computer acting as a network host for remote access to the display. By way of example, the properties that that can be monitored by the present invention include internal display temperature, display backlight brightness, backlight inverter current, ambient light levels, shock, loss of power to the display's processing unit, results of diagnostics performed by the display, results from colour gamut tests, touch screen functionality and haptic feedback such as forces and vibrations applied to a gaming display. This list is intended to be non-exhaustive, and many other display properties could be monitored by embodiments of the present invention.

The present invention therefore seeks to provide a system monitoring of public display devices for maintenance purposes to become a remote, instant operation. This allows for a more targeted work program for maintenance engineers, thus reducing company overheads, improving system up-time and reducing the expectations placed on staff working in proximity to the display devices, such as on-site shop staff.

In addition, the present invention seeks to provide a system which can perform pre-emptive maintenance, for example by monitoring the accumulated lifetime usage of backlights so they can be replaced before their failure.

Furthermore, using embodiments of the present invention it is possible to deactivate displays on a system that appear to be in the process of being vandalised, prior to the actual breakage of the display. In this case, the attacker will presume that he or she has already broken the screen, and will thus stop the attack. This aspect of the invention can be used in conjunction with a camera, such that the identity of the attacker can be ascertained.

### BRIEF DESCRIPTION OF THE DRAWINGS

Embodiments of the present invention are described below, by way of example only, with reference to the accompanying drawings, in which:

FIG. 1 is a representation of a display according to the present invention;

FIG. 2 is a representation of a system according to the present invention, in which a display is connected to a control centre via the Internet; and

FIG. 3 is a representation of a system similar to that of FIG. 2, but comprising a number of linked displays.

### DETAILED DESCRIPTION

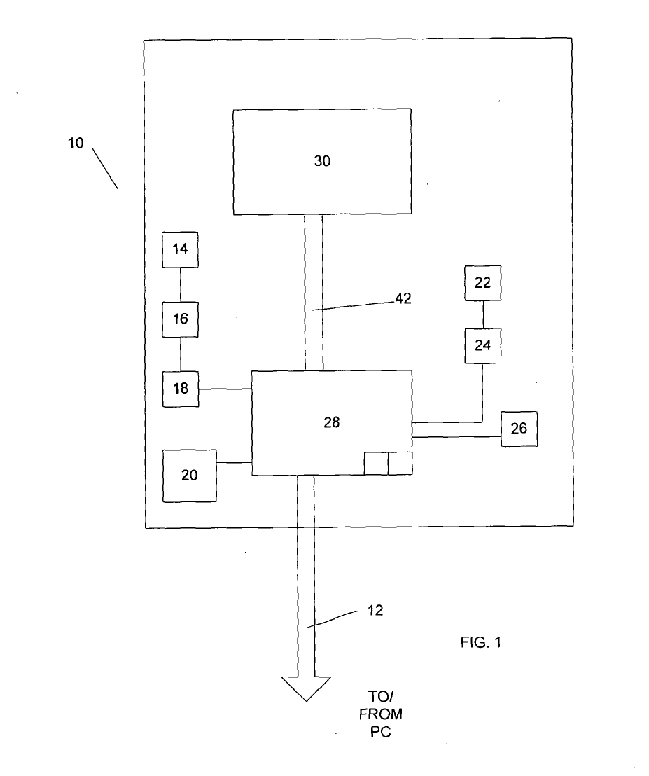

A display device according to an embodiment of the present invention is shown in FIG. 1. The display device 10 includes an input/output channel accessed by a digital visual interface (DVI) connector 12, for receiving data from a controlling PC (not shown) and for providing data thereto, and a number of sensors 14-26 operable to obtain respective data about a property of the display device. The sensors 14-26 are arranged to operate in response to the display device 10 receiving a request to poll the sensors 14-26 from the controlling PC via the DVI connector 12.

The display device 10 is configured to provide the data obtained by the sensors 14-26 to the controlling PC via the DVI connector 12. In one embodiment, the sensors 14-26 are each in communication with an analog-to-digital (A/D) converter 28, which is in turn in communication with the DVI connector 12 and thus with a controlling PC. The A/D converter 28 is further in communication with a screen 30 of the display via a low voltage differential signaling (LVDS) connector, such that a video signal can be provided from the PC to the screen 30 via the DVI connector 12 and A/D converter 28.

Extended display identification data (EDID) contained within the data display channel (DDC) of the DVI connector 12 is preferably utilised to implement the communications to and from the sensors 14-26. DDC version 2B is based on use of the I²C serial bus and the hardware (such as the sensors 16-26) is operable as a slave on the I²C serial bus. Preferably, the graphics adaptor is the master, thereby polling the monitor and the hardware of the present invention.

In the example shown in FIG. 1, the sensors 14-26 are individually configured to obtain data relating to the following properties of the display:

| Sensor | Property |
|---|---|
| 14 | Haptic feedback |
| 16 | Backlight brightness |
| 18 | Backlight inverter current |
| 20 | Ambient light |
| 22 | Touch overlay |
| 24 | Touch controller |
| 26 | Shock |

It should be understood that this list of properties is provided by way of example only, and is not intended to be limiting on the scope of the invention.

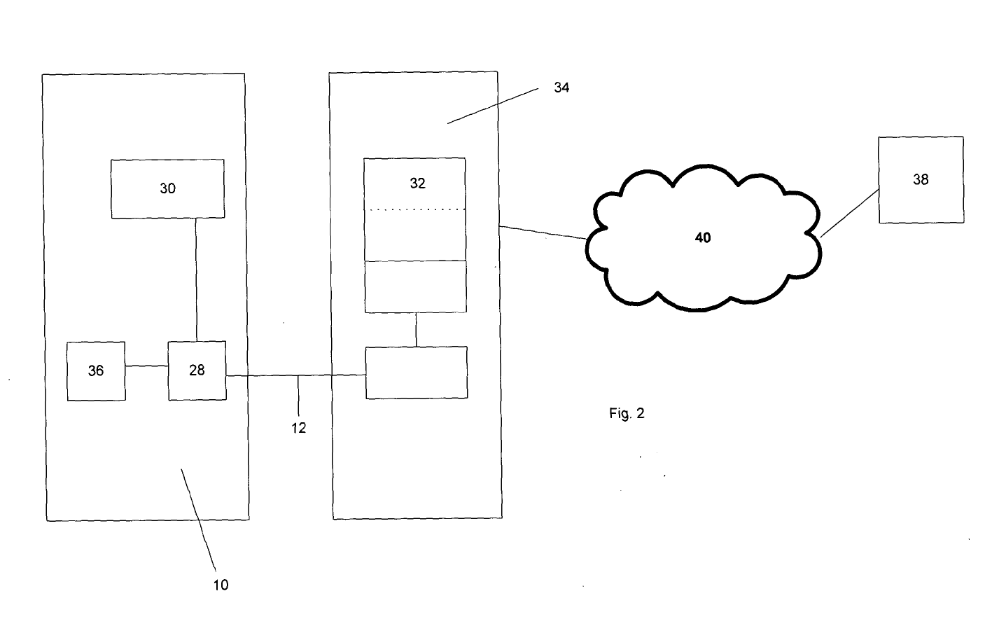

FIG. 2 shows a system according to the present invention for monitoring at least one property of a display device 10, such as the display device shown in FIG. 1. The system comprises a monitoring unit 32 residing on a local computer 34. The local computer 34, and thus the monitoring unit 32, are preferably connected by a display cable to the display panel. Sensors, similar to the sensors 14-26 of FIG. 1, are indicated generally by the reference numeral 36 and are associated with the display device 10. The sensors 36 are operable to obtain respective data about a property of the display device 10. The monitoring unit 32 and the display device 10 are in communication, via the DVI connector 12 and A/D converter 28, such that the sensors 36 can operate in response to the display device 10 receiving a request to poll the sensors 36 from the monitoring unit 32, and to provide the data obtained by the sensors 36 to the monitoring unit 32.

In a preferred embodiment, the local computer 34 is connected to a remote control centre 38 via a network such as the Internet 40.

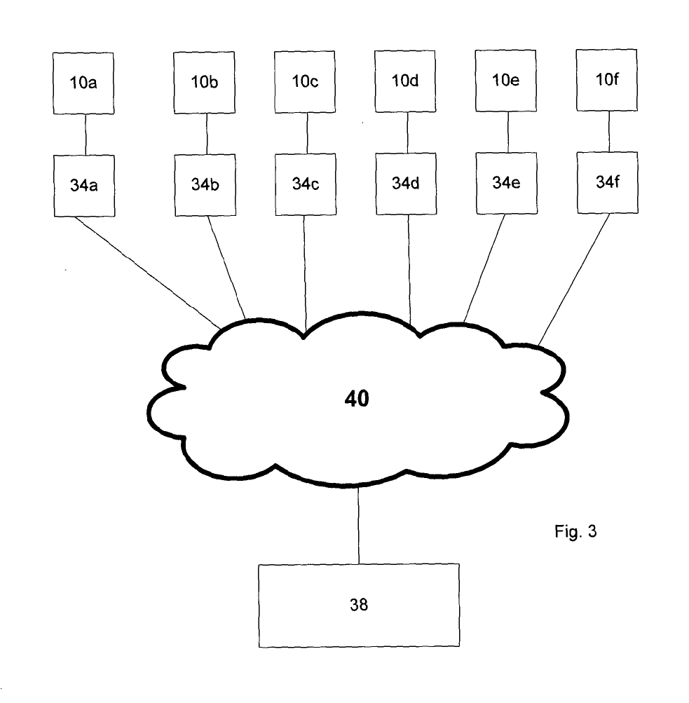

The system described in FIG. 2 may in practice comprise a number of display devices 10 connected to a single control centre 38 via a network or networks. FIG. 3 shows a system similar to that of FIG. 2, but comprising a number of linked displays 10a-10f. Each display 10a-10f is in communication with a respective local computer 34a-34f. Each local computer 34a-34f includes a gateway system (not shown) which is arranged to receive requests for its respective display device 10 to poll the sensors contained therein (the sensors are not shown in FIG. 3 for clarity), and to provide the data obtained by the sensors. Each local computer 34a-34f is connected to a control centre 38 via the Internet 40.

In the embodiments described in FIGS. 2 and 3, the monitoring unit 32 includes a dynamic linked library (DLL) that executes on the local computer and presents an application programming interface (API) to the user's application software. This allows a user to link in remote monitors and/or functions that monitor those properties of the display device(s) provided for by the sensors 14-26, control those properties of the display device(s), or control the sensors 14-26 themselves.

The monitoring unit 32 can be implemented in hardware, software and/or firmware in the local computer 34, which is in communication with the display device via the DVI connector 12 and A/D converter 28 such that the properties of the display device(s) can be monitored and/or controlled, or such that the sensors 14-26 can be controlled, by means of the controlling PC 34.

Alternatively, in an arrangement such as that shown in FIG. 3, the local computer 34 may be omitted and the monitoring unit 32 can be incorporated in the display device, such that the display device communicates via the Internet 40. In this way, the properties of a number of display devices 10a-10f can be directly monitored and/or controlled, or the sensors 14-26 of each display device 10a-10f can be controlled, centrally at the control centre 38 without the need for intermediary systems. An intermediary system could optionally be used to provide the display signal but could be bypassed for monitoring.

An example use of an embodiment the present invention is the monitoring of the inverter current of the display backlight. This serves as an indicator as to whether the backlight has burnt out. The backlight inverter current is monitored by one of the sensors 18 of the present invention, which is connected to the DDC bus. The monitoring unit 32 polls the sensor, requesting the status of the backlight inverter current on a regular basis. Upon the monitoring unit 32 ascertaining that the backlight inverter current has dropped below a predetermined threshold value, this is taken as an indicator that the backlight may have burnt out. The monitoring unit can present this information to the control centre via the Internet and/or it could also trigger other remote (SMS, email etc) or local alerts. The control centre can then flag this information as a problem such that an engineer is sent to the site of the display device in question to physically check the display device in question, and to replace the backlight if appropriate.

A further example application of the present invention is the monitoring of movement of the display device as an indication of physical shock, and the subsequent control of the backlight to temporarily deactivate the display device. This may be used in situations where an angry user attempts to attack the display device by providing a series of bangs or jolts to the screen. An internal accelerometer is provided in the display device to act as a shock sensor, which can be polled by a controller using the application software. The monitoring unit processes the data provided by the accelerometer in order to detect an increase above a predetermined threshold value. On detecting such an increase, indicative of an attack being carried out on the display device in question, the monitoring unit sends a command to the display device to temporarily disable the display backlight or other components such that the display device is temporarily deactivated. Once the display backlight has been disabled the attacker will assume that the display device has been broken and will cease the attack. The display backlight can be re-enabled a predetermined time after the attack has ceased. As an additional feature, the display device may be fitted with a camera which is in communication with the application software via the A/D converter and DVI connector, thus enabling the application software to trigger the camera to take a picture of the attacker. This application may find use with display devices used in gaming machines, for example gaming machines provided in betting shops.

Further and/or supplemental to the above description, certain features of embodiments the present invention are as follows:

### AD Power/Fault Detection

The A/D unit is the main video/scalar card within the monitor, and its health can be monitored in an embodiment of the present invention. In the event of the loss of power of the A/D card, the sensors and associated processing components in embodiments of the present invention are preferably separate components and will still receive power through the video cable, and maintain the DDC link in order to report the fault condition.

### Internal Temperature Sensor

A sensor may be provided for monitoring of the internal temperature of the display device.

### 3-Axis Accelerometer

An accelerometer may be provided for the detection of rapid shocks, as well as screen angle, and knock-overs.

### Backlight Inverter Current Detection

A current sensor may be provided for detection of either inverter faults, CFL tube burn-outs/breakages, or LED backlight faults.

### Backlight On/Off Control

Means may be provided for control of the backlight, such that the screen can be switched on and off from a remote location.

### Backlight Dimming Control

Means may be provided for dimming control of the backlight, for example to dim the backlight in low ambient light conditions. With LED backlights, this is particularly important in order to improve the backlight lifetime.

### IR Proximity Sensor

Means may be provided for collating data relating to whether a user is present in front of a display device, as well as data relating to the length of time the user spends in front of the display device.

### Spare Buttons

Spare buttons may be provided on the display device, such that the display device can provide for customised display applications.

### Light Sensors

One or more light sensors may be used: (i) internally to detect whether the backlight is functioning correctly; (ii) externally as an ambient light sensor to trigger the application software to dim the display backlight in low ambient light conditions, thereby saving power and backlight lifetime; and (iii) to detect touch system LED activity, as an indicator of correct functioning of the touch system.

### Touch System Power Detection

Means may be provided for electrically detecting the presence of power to the touch system.

### CCTaIk Connection

Means may be provided for monitoring and control of CCTaIk-compatible devices, such as coin-counters.

### EEPROM

Electrically erasable programmable read-only memory (EEPROM) may be provided to store for example lifetime information, serial numbers, custom configuration, traceability and warranty checks.

### Other Benefits

An embodiment of the present invention can be arranged to provide a distributed network of accelerometers with possible time-synchronisation. As such, it would be possible to collate data from multiple sites across hundreds of miles, in which case the system could find application in the detection of earthquakes. The location of an earthquake epicentre could also be calculated using such a system.

The API of the user's application software may provide the following functions;

### FW Functions:

BL light sensor, ADC and send to DDC
Ext light sensor, ADC and send to DDC
Temp sensor, ADC and send to DDC
BL current ADC and send to DDC
Proximity sensor, ADC and send to DDC (set event if configured)
Accelerometer sensor, read and send to DDC (convert, set event if configured)
Buttons, read and send to DDC (on press set event if configured)
Get/Set Timers for auto poll sensors
Get/Set backlight (%)
Auto backlight control upon Ext. Light, Proximity events (config in EEPROM, can work without PC app)
Get/Set Serial number, Password (EEPROM)
Get firmware version and list of the acceptable commands for DLL
Firmware updating:
   Loader routine, receives encrypted FW packets from DDC
   Flash handler
   FW packet decrypting
ccTalk:
   USART, timer, fifo
   Set baud
   Set checksum mode (8 bit/16 bit/CRC)
   write command to ccTalk from DDC
   receive ccTalk response, check chksum, set event flag for DDC poll
   send ccTalk response to DDC upon PC request
   send raw ccTalk receive fifo to DDC upon PC request (if not empty).

In alternate embodiments of the present invention, the number, type and/or function of the sensors could differ from those described herein to provide data relating to any other suitable property of the display device. Further, although the display device has been described as comprising a plurality of sensors, there could be a single sensor. The single sensor could provide data relating to a single property, or could be arranged so as to provide data relating to a plurality of properties.

In addition, although the input/output channel has been described in the form of a DVI connector, any other suitable type of connector capable of providing a DDC EDID link could be used. For example, the input/output channel could comprise a video graphics array (VGA) or High-Definition Multimedia Interface (HDMI) connector.

The link between the A/D converter and the screen has been described as a LVDS connector, but the link could comprise any other suitable form of data display cable.

Further, the graphics adaptor has been described as a A/D converter, but any other suitable form of graphics adaptor could be used.

The system described in FIG. 3 comprises six linked displays, but it is to be understood that in reality any number of displays could be linked to form a network.

In addition, the local computers are described as being linked to the control centre via the Internet, however any other suitable form of over-the-air network could be used.

The disclosures in United Kingdom patent application no. 1107167.7, from which this application claims priority, and in the abstract accompanying this application, are incorporated herein by reference.

1. A display device comprising:
an input/output channel for receiving data from a source; and
at least one sensor operable to obtain sensor data on the display device, at least selected ones of the or each sensor being arranged to operate in response to the display device receiving a request in the data from the source via the input/output channel;
the display device being arranged to output the sensor data obtained by the or each sensor to the source via the input/output channel.

2. A display device according to claim 1 further comprising a graphics subsystem in communication with the input/output channel, wherein the at least selected ones of the sensors being arranged to operate in response to the graphics subsystem receiving the request in data from the source.

3. A display device according to claim 2 wherein the graphics subsystem includes an A/D converter.

4. A display device according to claim 1 wherein the input/output channel includes extended display identification formatted data.

5. A display device according to claim 1, further comprising a sensor controller, the sensor controller being arranged to monitor the input/output channel for the request and selectively control one or more of the sensors in dependence on the request.

6. A display device according to claim 1, wherein the or each sensor is operable to obtain respective data about a property of the display device selected from a list comprising: haptic feedback, backlight brightness, backlight inverter current, ambient light, touch overlay, touch controller, shock, internal temperature colour gamut and user proximity.

7. A display device according to claim 1, further comprising a device controller operable to control at least one property of the display device, the device controller being arranged to operate in response to the display device receiving a request to control the at least one property of the display device via the input/output channel.

8. A display device according to claim 7 wherein the at least one property is selected from: backlight power and backlight brightness.

9. A display device according to claim 7, wherein the device controller is arranged to control the property whereby the display appears non-operational.

10. A display device according to claim 9, wherein the device controller is arranged to control the property to revert the display to an operational appearance after a predetermined time.

11. A system for monitoring at least one property of a display device, the system comprising:
a display device according to claim 1; and,
a monitoring unit;
wherein the monitoring unit is connectable to the one or more sensors via the input/output channel to provide the request and receive the sensor data from the one or more sensors to thereby monitor the at least one property of the display device.

12. A system according to claim 11, wherein the monitoring unit is encoded in a display device driver, the display device driver being arranged to be executed on a source computer connected via the input/output channel to the display for displaying content from the source.

13. A system according to claim 12, wherein the display device driver is arranged to act as an intermediary bridging between a node connected to the source on a data network and the one or more sensors, the display device driver being arranged to relay the request and sensor data between the one or more sensors and the node.

14. A system according to claim 11, wherein the monitoring unit is arranged to communicate with a data communication network.

15. A system according to claim 11 wherein monitoring unit is a display adapter.

16. A system according to claim 11, wherein the display device includes the monitoring unit.

17. A method of monitoring at least one property of a display device having at least one sensor associated with the display device and operable to obtain respective data about a property of the display device, the method comprising:
generating a request at a monitoring unit for the display device to poll the or each sensor; and
receiving data obtained by the or each sensor in response to the request.

18. A method according to claim 17 wherein the request to poll the or each sensor comprises a request to obtain respective data about a property of the display device selected from a list comprising: haptic feedback, backlight brightness, backlight inverter current, ambient light, touch overlay, touch controller, shock, internal temperature and user proximity.

19. A method according to claim 17 further comprising controlling at least one property of the display device, in response to the display device receiving a request to control the at least one property of the display device.

20. A method according to claim 19 wherein the at least one property is selected from: backlight power and backlight brightness.

21. (canceled)

22. (canceled)
